(19) United States
(12) Patent Application Publication
(10) Pub. No.: US 2025/0125595 A1
(43) Pub. Date: Apr. 17, 2025

(54) CABLE STRIPPING KNIFE FOR RIBBON CABLES

(71) Applicant: WEICON GmbH & Co KG, Münster (DE)

(72) Inventors: Ralph Weidling, Münster (DE); Heinrich Bär, Münster (DE); Paul Wolters, Dülmen (DE)

(21) Appl. No.: 19/001,680

(22) Filed: Dec. 26, 2024

Related U.S. Application Data
(63) Continuation of application No. PCT/EP2023/067057, filed on Jun. 22, 2023.

(30) Foreign Application Priority Data
Jun. 28, 2022 (DE) 20 2022 103 595.4
Apr. 14, 2023 (DE) 20 2023 101 894.7

(51) Int. Cl. H02G 1/12

(52) U.S. Cl. CPC H02G 1/1231

(57) ABSTRACT

A tool for stripping wire from cable, particularly flat cable. The tool has a handle, a slide having a free end that is movable relative to the handle, and a blade. The front end of the handle and the free end of the slide form two sides of a cable channel through which cable is pulled lengthwise to cut into an outer layer of insulation, one side being a guide groove where the blade is positioned and the other side a cable recess. The cable recess is specifically formed to prevent flat cable from twisting as it is pulled through the cable channel. Movable elements are provided in the cable recess that automatically adapt to the specific geometry of the cable, thereby changing the size and shape of the cable channel, depending on the cable, thus making the tool well-suited for cutting round cable, as well as flat cable.

### BACKGROUND INFORMATION

### Field of the Invention

The invention relates to the field of wire stripping tools. More particularly, the invention relates to a tool for stripping flat cable. More particularly yet, the invention relates to a tool that for stripping round as well as flat cable.

### Discussion of the Prior Art

DE 10 2007 032 399 B3, DE 100 01 002 C2, CN 209 434 790 U, and GB 2 602 820 A disclose conventional tools for stripping insulation from electrical conductors. The conventional cable knives have proven to be excellent in slitting the outer insulation sheath on round cable. Such tools have a handle and a movable slide attached to the handle. To insert a cable into the tool, the slide is moved away from the handle to open up a space to receive the cable. The slide is then pulled back toward the handle, so as to reliably hold the cable in the slide. A blade that is mounted in the handle and projects into the space that receives the cable then makes a cut in the outer insulation as the cable is pulled lengthwise through the slide. These tools are also very safe to use and handle, because when the slide is pulled as close as possible to the handle, and particularly, if no cable is inserted into the tool, the slide covers the blade, thus preventing inadvertently being injured by the blade.

DE 10 2016 103 972 A1 and FR 2 818 040 A1 disclose wire stripping tools that also have a guide channel with a fixed opening angle that serves to guide the cable. DE 10 2016 103 972 A1 also provides two rollers that rotate freely on axes that are aligned to form the fixed opening angle.

Many of these conventional wire stripping tools are not suitable for stripping insulation from flat cable, which typically has narrow sides. When pulling thin flat cable through the slide of a conventional stripping tool, it will sometimes twist about its longitudinal axis, so that the incision being made by the blade may not extend along the desired narrow side of the cable, but slip onto the top or bottom surface of the cable and possibly damage an individual conductor that is encased in the flat cable.

What is needed, therefore, is a tool for stripping cable that reliably holds flat cable in a desired orientation. What is further needed is such a tool that automatically adapts to the specific geometry of the cable to be processed. What is yet further needed is a tool that is suitable for stripping round and flat cable, thereby avoiding the need to use multiple tools to cut different types of cable.

### BRIEF SUMMARY OF THE INVENTION

It is an object of the invention to improve on the conventional cable knife such that the tool is suitable for cutting the outer layer of insulation on flat as well as round cable and to provide a tool that facilitates a simple and reliable stripping operation on various types of cable.

The tool according to the invention for stripping wire, referred to hereinafter as a cable knife comprises a handle, a slide that is movably attached to the handle, and a cable channel through which the flat or round cable is pulled is adaptable to the specific geometry of the cable and maintains the cable in its proper orientation as it is pulled through the channel in order to make a longitudinal cut in an outer layer of insulation. The cable channel is expandable, as the slide is movable closer to or farther away from the front end of the handle, depending on the width of the cable to be processed. An adjustable blade extends from the handle or the slide into the cable channel sufficiently to make a cut in the outer insulation sheath on the cable as the cable is pulled through the channel. The handle has a housing that is formed from two half-shells.

The cable channel in the cable knife according to the invention has two opposing sides that include a cable recess on the one side and a guide groove on the other side. The cable recess is formed by a contour on one of the two components, either the slide or the handle, and the guide groove on the other component. But the handle provides more space to accommodate the blade, particularly if the blade assembly includes a mechanism for adjusting the depth of cut, so the following description of the cable knife will describe the blade as being mounted in the handle and the guide recess being on the movable slide. This is purely for reasons of simplicity, and it is understood that the described configuration of these elements is not limiting, i.e., the configuration may be reversed and the cable recess provided on the handle and the guide groove on the slide.

The contour of the cable recess begins as an approximately U-shaped channel having a base and two recess walls that form an opening, i.e., a channel, that extends toward the handle. The guide groove is a V-shaped contour at a front end of the handle that faces the slide. The cable recess on the slide and the guide groove on the handle together form a cable channel through which a flat or round cable is pulled. Each of the walls of the recess has a first recess section that extends from the base of the recess and at some point transitions into a second recess section that then extends from the end of the first recess section toward the handle. The two walls of the first recess section form a first opening angle and the two walls of the second recess section form a second opening angle that is more sharply angled than the first opening angle, thereby providing a wider clearance area in a region that is closer to the handle than to the slide. In other words, the two second recess sections of the recess walls are angled relatively sharply outward from a central longitudinal axis that runs through the handle and slide, to form a wider section of the recess. These two opposite walls of the cable recess provide defined, fixed contours of the two opposing sides of cable channel, i.e., a clearance area or open space through which cable, and particularly, flat cable, is pulled to make a cut in the outer insulation layer.

The sides of the V shaped guide groove extend towards the edges of the handle. This V shape allows the cable knife to be adaptable to different cross-sectional geometries of flat cable, because the sides of thin as well as and flat cables that are inserted into the guide groove make contact with these sides, and that contributes to reliably maintaining the cable in a desired orientation as it moves through the cable channel.

The blade extends from the handle into the cable channel at the center of the guide groove. When a flat cable is inserted into the cable channel, one of the two narrow sides of the flat cable makes contact against the first recess section, i.e., the narrow section, of the cable recess, and the other narrow side of the flat cable is brought into contact with the blade that is positioned at the guide groove, so that, when the flat cable is pulled lengthwise through the cable channel, the blade makes a cut in the outer layer of insulation along this narrow side, and possibly along the entire length of the cable.

As mentioned above, the walls in the first recess section form a narrow channel. The recess walls in this first section are relatively close together and very slightly angled outward from a central longitudinal axis that extends through the recess, in other words, the two walls are almost parallel to each other, thereby forming a narrow recess channel through which at least a portion of the width of a flat cable runs as it is pulled through the cable channel. This narrow recess channel effectively maintains the proper orientation of the cable throughout the pulling operation, thus, it reduces the risk of a flat cable twisting about its longitudinal axis and tilting away from the blade. Thus, it ensures that the cut into the flat cable is reliably produced at the same circumferential location along the entire length of cut in the flat cable. The fact that the cable maintains the proper orientation also ensures that the blade penetrates only to the desired depth into the outer insulation and does not, for example, cut into an undesired circumferential portion of the flat cable, where the layer thickness of the outer insulation sleeve might be thinner and where the cut could damage the insulation on the internal electrical conductors.

A movably mounted guide element may also be mounted on each of the two opposite sides of the cable recess. These two guide elements extend into the cable recess and alter the shape of the cable channel, such that the cable comes into direct contact with these segments. The contact of the guide elements against the cable further contributes to maintaining the proper orientation of the cable as it is pulled through the cable knife. Given that the geometries of cable to be stripped may vary widely, these guide elements are mounted in a way that allows them to assume tilted positions, whereby the specific angle the guide elements assume depends on the particular cross-section of the cable. In other words, these guide elements effectively change the shape of the cable channel and optimally guide the cable through the channel by automatically adapting their position to the specific cross-section of the cable. Given otherwise identical materials, thin flat cables are more flexible than thicker cables, due to their smaller cross-sectional area, and because of that, they are more prone to twisting about their longitudinal axis when being pulled through the tool, which means that the cables can tilt away from the blade. But inserting a thin flat cable into the cable knife according to the invention forces the guide elements apart, and, given the thin flat shape of the cable, they automatically take on position that is almost parallel to each other, thereby effectively narrowing the cable channel to a dimension that will securely guide the flat cable in its proper orientation.

The two inventive features described above, the cable recess and guide groove on the one hand and the movable guide elements on the other hand, are not mutually exclusive. The cable knife according to the invention may include the cable recess and guide groove, as well as the movable guide elements. The first and second sections of the recess walls were described as being straight walls that are angled and, thus, extend along two different planes, creating a first recess section that has a narrower opening angle and a second recess section that has a much wider opening angle. The cable recess and guide groove are fixed contours, but the guide elements are movable and assume a certain position, depending on the specific geometry of the cable to be processed in the cable knife. These two guide elements are able to take on different positions and if each of the two guide elements takes on a curved or angled position, the shape of the cable channel changes in that the first section becomes narrower and the second section wider. In other words, the overall shape of the cable channel in a cable knife that includes the guide elements is changeable and is determined by the specific geometry of the cable in the cable channel.

The two guide elements may also be provided on different planes. For example, they may be offset to one another in the longitudinal direction of the cable, so that they can each extend beyond a centerline that extends in the longitudinal direction of the cable when they assume inclined positions with an obtuse opening angle. This offset allows the guide elements to assume as many different positions as possible relative to each other when accommodating various cross-sectional geometries of flat cables.

It is desirable, that the guide elements have a thickness dimension that provides the greatest possible contact area with a cable. The guide elements pivot, depending on the thickness of the cable and when they assume a wide opening angle toward the handle, the ends of the guide elements that extend into the region of the cable recess that is very narrow, these ends may collide. Thus, the guide elements may have a notch, i.e., a reduced width, at those ends, so that both guide elements can pivot into a narrow region of the free end of the slide and fit close together, without colliding with each other. Thus, depending on the specific geometry of the cable, the guide elements may make contact across their full width with a variety of cables, with some cable geometries, the guide elements may make contact with a portion that has the full width and a portion that has the notch with the reduced width, and in a few cases, the guide elements may be in contact with the cable only with their narrower width in the area of the notch.

Limiting the notches of the two guide elements relative to just one area of the respective guide element is advantageous for two reasons. One, it is possible to mount the guide elements opposite one another without an axial offset with respect to the longitudinal direction of the cable, i.e., one above the other. XX, i.e., one above the other. This congruent arrangement means that friction or braking forces exerted by the guide elements on the cable are symmetrical, thereby avoiding any distortion of the cable as it is pulled through the cable channel and ensuring that the cable moves through the cable channel in a positionally stable manner, whereby “positionally stable” in this context means that the cross section of the cable maintains its orientation, with as little change as possible, as it moves through the cable channel, i.e., the cable does not tilt or twist about its longitudinal axis in the cable channel.

Two, this allows a widest possible construction of the guide elements, which is advantageous, because it achieves the greatest contact area between the guide elements and the cable. For example, the guide elements may be between 4 and 7 mm wide, and particularly 5 mm or more. This structurally greater width of the guide elements is possible because the two guide elements do not have to be mounted completely offset to one another in the cable knife and the installation space available for mounting the guide elements encompasses the full width of the space for each guide elements, rather than just the half of the space. Surprisingly, the greater width and, thus, the larger contact area that a surface of a guide element has with the cable does not increase the pull-through resistance on the cable, but rather reduces it. The larger contact area reduces the surface pressure between the guide elements and the cable, and thus, reduces the likelihood that the guide elements will deform or dent a soft, easily deformable layer of insulation. Such a deformation would in effect create a type of form fit between the cable and the guide elements and the work done to create the dent would have an adverse effect on the pull-through resistance on the cable.

The two guide elements may be pivotably mounted as a simple way to provide the desired movability of the elements. Initial practical experiments have shown that this type of mounting is well-suited to provide a problem-free and automatic adaptive positioning of the guide elements to accommodate the specific cross-sectional geometry of the flat cable.

A bead may be provided on each the two movable guide elements on a section of the guide element that is closer to the handle than to the handle, that is to say, in a section where the cable channel is wider. The purpose of the bead is to better guide a thin flat cable by selectively narrowing the clearance area in this section of the cable channel. At the same time, mounting the beads on the section of the guide elements that extends into in the second recess section of the cable channel leaves a largest possible free space between the guide elements, thereby allowing round cables to be guided through the cable channel. This combination of the guide elements and the beads in the cable knife according to the invention provides a tool that is particularly well-suited for processing flat cable, but is also well-suited for processing round cable, and particularly round cable that has a diameter that is typically encountered in the field, i.e., from 4 to 13 mm.

As mentioned above, the blade is mounted in the handle and projects into the guide groove. Ideally, the blade is adjustable in the longitudinal direction of the handle, so that the blade may be adjusted to the precise depth to make the desired cut in the outer layer of insulation. This ability to adjust the depth of cut also increases the versatility to the cable knife according to the invention, because it is able to process different cable types with varying thicknesses in insulation material. The blade may be spring-loaded, so that the spring force urges it automatically toward the outer insulation of the cable. The blade by itself may be spring-loaded, or it may be held in a blade holder, and the blade assembly, i.e., the blade and blade holder, be spring-loaded. A cable connected to the blade or blade holder may be provided as a means to retract the blade into the handle.

The blade may be a double-edged blade. This allows incisions to be introduced into the outer layer of the cable insulation in both directions of the longitudinal direction of the cable. The benefit of a double-edged blade is that the cable knife according to the invention is suitable for use by right-handed and left-handed operators and it also has a particularly long service life-practically twice as long compared to cable knife having a single-edged blade.

The blade may also be rotatably mounted. With this rotatable mounting, the blade may be used to make a cut in the longitudinal direction of round or flat cable, and also to be rotated through 90 degrees upward or downward, to make a circumferential cut in round cable, i.e., cut transverse to the longitudinal direction of the cable. This further enhances the versatility of the cable knife according to the invention, because the cable knife may be used to process different types of cable. For example, an operator may use the cable knife according to the invention to alternately strip round and flat cable, thereby avoiding the need to switch tools because different cable knives are required to cut round and flat cable.

When inserting cable into the cable channel, the free end of the slide is moved away from the housing to create a sufficiently large opening. A so-called opening surface may be provided on the slide, to facilitate opening the slide. This opening surface is constructed as protuberance that projects upward from the handle and against which an operator pushes with his or her thumb to push the free end of the slide away from the handle, against the spring action that urges the slide up against the handle. This makes the cable knife particularly easy to use, because the cable channel may be opened to insert the flat cable simply by pressing against the opening surface with a thumb. The spring force then urges the slide to move back, and simply removing the pressure from the opening surface allows the spring force to act on the slide and move it back toward the handle.

The opening surface may also include a closing surface that is provided on the side of the protuberance opposite the opening surface. If the operator wishes to assist the spring-urged closing of the slide, he or she may apply pressure to this closing profile with a finger or thumb and push the slide toward the handle. Moving the slide as close as possible to the handle after the cable has been inserted ensures that flat cable is guided in an optimum manner.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a perspective view of the underside of a first embodiment of the cable knife.

FIG. 2 is a side plane view of the cable knife.

FIG. 3 is a bottom plane view of the cable knife.

FIG. 4 is a side elevational view of a second embodiment of the cable knife showing a cross-sectional view of the slide along the section line IV-IV in FIG. 3.

FIG. 5 is a side plane view of the slide of the cable knife.

FIG. 6 is a partial cross-sectional view of the slide along the section line VI-VI in FIG. 5, showing a lateral offset of the guide elements.

FIG. 7 shows a side view of the cable knife showing a thicker flat cable inserted into the cable recess.

FIG. 8 is a side view of the cable knife showing a thinner flat cable inserted into the cable recess.

FIG. 9 is a plane elevation view of a third embodiment of the cable knife according to the invention, showing a bead mounted on the guide element.

FIG. 10 is a cross-sectional view along the section line X-X shown in FIG. 9, showing two guide elements mounted one directly above the other.

FIG. 11 is a cross-sectional view of the slide, showing a notch in one of the guide elements.

FIG. 12 is a plane elevation view of a front end of the cable knife, showing a thin flat cable inserted into the cable recess.

FIG. 13 is a plane elevation view of the third embodiment of the cable knife according to the invention, showing the orientation of the guide elements when a round cable (not shown) of large diameter is inserted.

FIG. 14 is a view of the slide, showing the ends of the guide elements positioned next to each other when a large round cable is inserted into the cable channel.

FIG. 15 is cross-sectional view of the slide, showing a part of the guide in a region of the notch fitting side by side.

FIG. 16 is a plane view of the third embodiment of the cable knife according to the invention, showing a round cable inserted into cable channel.

FIG. 17 is a side view of the entire cable knife, with a cross-sectional view of the slide, showing a round cable inserted into the cable channel and the blade in position to make a cut.

FIG. 18 is a plane elevation view of the slide and the front end of the handle, showing a flat cable in the cable channel, with the beads making contact against the cable.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

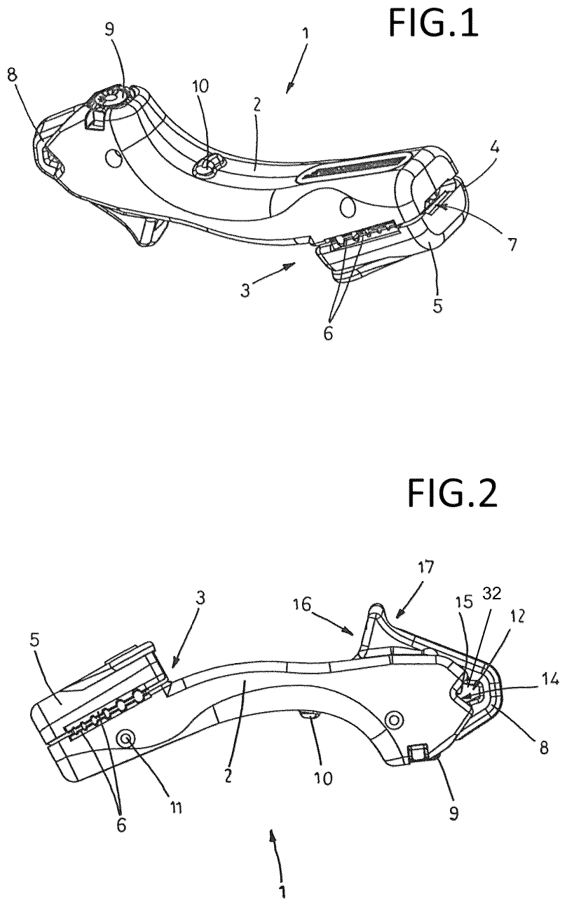

FIG. 1 is a perspective view of the underside of a cable knife 1 according to the invention. The cable knife 1 has a handle 2 that includes a foldable stripping section 3. An actuating part 5 of the stripping section 3 is foldable about a folding axis 4 in order to open the stripping section 3 and separate two stripping blades 6. The actuating part 5 is spring-loaded to hold it in the closed position shown in FIG. 1, and is pivotable about the folding axis 4 against the action of the spring into the open position. Each of the two stripping blades 6 has a plurality of approximately semicircular recesses of various sizes, so as to accommodate and strip the insulation from electrical wires of various dimensions.

The actuating part 5 and a stationary part of the handle 2 together form a knife opening 7 at one end of the cable knife. Two paired knife blades (not shown in FIG. 1) are provided in the knife opening 7 for the purpose of cutting through an outer layer of insulation on a flat cable circumferentially, thereby allowing one end of the insulation to be stripped from the flat cable up to this circumferential incision. Rotating the flat cable in the knife opening 7 about its longitudinal axis opens the knife opening 7 by forcing the actuating part 5 to fold out about the folding axis 4, whereby the spring force holds it against the flat cable.

Once the outer layer of insulation has been stripped from a cable, the insulation is then stripped from the individual conductors with the aid of the stripping blades 6. The handle 2 and the end of the actuating part 5 that is opposite the knife opening 7 form an opening that allows a flat cable to be inserted into the cable knife 1 as far as needed.

A slide 8 is provided at the end of the handle 2 that is opposite to the knife opening 7, and an adjustment wheel 9 and a finger support 10 are provided on the underside of the handle 2. These elements will be discussed in more detail later.

FIG. 2 is a plane elevation view of the cable knife 1, showing fastener elements, for example, screws 11 that are used to fasten two half shells of the handle housing together. It is understood that other suitable connector elements, such as rivets or other connecting elements, may be used, or that the two half-shells may be glued or welded together.

FIG. 2 illustrates a first embodiment of the cable knife 1 according to the invention. The slide 8 is shown in a closed position up against the handle 2. A V-shaped contour on the handle 2 forms a guide groove 14 and a contour on the slide 8 forms a cable recess 12, whereby it is understood that this particular configuration of the guide groove 14 on the handle 2 and the cable recess 12 may be reversed, i.e., the guide groove be formed on the slide 8 and the cable recess 12 formed on the handle 2. A blade 15 that serves to make a cut in the outer insulation layer of the flat cable is held in the handle 2 in the longitudinal direction of the handle 2, whereby the tip of the blade 15 extends into the guide groove 14 where the two sides of the groove come together for form the point of the V. Together, the guide groove 14 and cable recess 12 form a clearance profile or a cable channel 32 that is changeable in shape and dimensioned to accommodate various types and dimensions of cable, including round cable and, particularly, flat cable. The intended use of the cable knife 1 according to the invention is to strip insulation from flat cable and, thus, the following description of how the cable knife 1 functions will frequently refer to flat cable, although the cable knife 1 according to the invention is also well-suited to strip insulation from round cable. And also, because the handle 2 has more space available to hold the blade 15, the following description will describe the blade 15 as being mounted in the handle 2.

To make a longitudinal cut in the cable, it is pulled lengthwise and

transversely to a longitudinal axis of the cable knife 1 through the cable channel 32 and past the blade 15. If the cable is a flat cable, this longitudinal cut may be made before or after the circumferential cut is made into the outer layer of insulation at the knife opening 7. If the cable is a round cable, the circumferential cut may be made by blade 15, as will be described later. In any case, the longitudinal cut reduces the friction between the outer layer of insulation and the insulation on the inner electrical conductors to such an extent that, when both the longitudinal cut and the circumferential cut have been made, an operator is able to easily strip the outer layer of insulation from the cable.

The slide 8 is movably attached to the handle 2 and FIG. 2 shows the slide 8 in a closed position, i.e., up against the handle 2. The operator moves a free end 21 of the slide 8 away from the handle 2 to open up a space that allows the cable to be inserted. To facilitate opening the slide 8, a contoured surface having a first side that serves as an opening surface 16 is provided on an upper side of the slide 8. This opening surface 16 is provided such, that when the operator holds the cable knife 1 in his or her hand, simply placing a thumb on the opening surface 16 and applying pressure forces the free end of the slide 8 away from the handle 2. A finger support 10 can serve as counter support for the index finger and thus enhance a controlled application of force against the opening surface 16.

Releasing pressure from the opening surface 16 allows the spring action to urge the slide 8 back toward the handle 2. It may be desirable to manually support this movement back to the closed position, instead of relying solely on the spring force. To this end, a closing surface 17 may be provided on a second side of the contoured surface. The operator may use a thumb or finger to engage with this closing surface 17 to pull the slide 8 toward the handle 2.

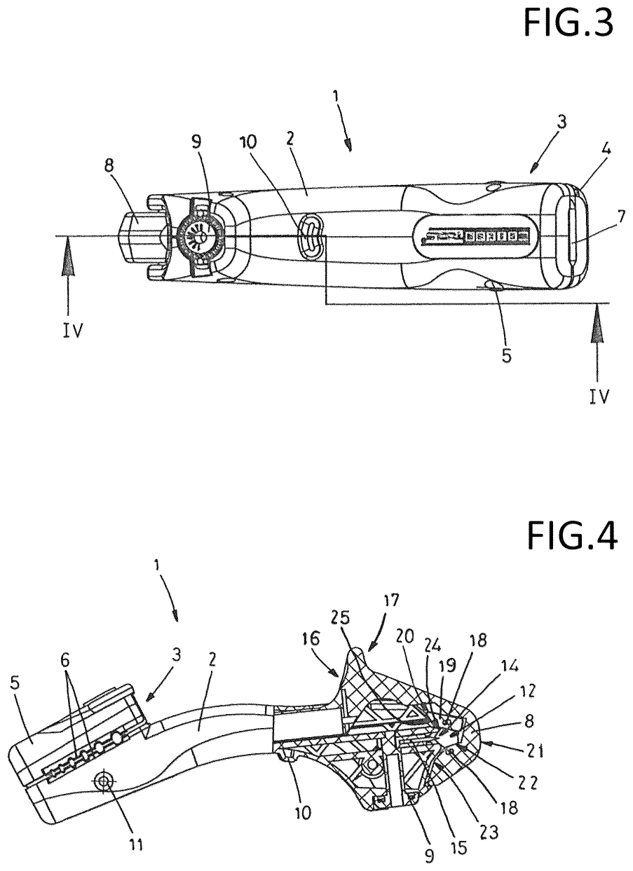

FIG. 3 is a plane view of the underside of the cable knife 1, indicating a cross-sectional plane IV-IV that is shown in FIG. 4. The blade 15 is mounted in a knife holder that is connected to an eccentric means that is connected to the adjustment wheel 9. Turning the adjustment wheel 9 in one direction pushes the blade 15 farther into the guide groove 14 and in the other direction retracts the blade 15 deeper into the handle 2.

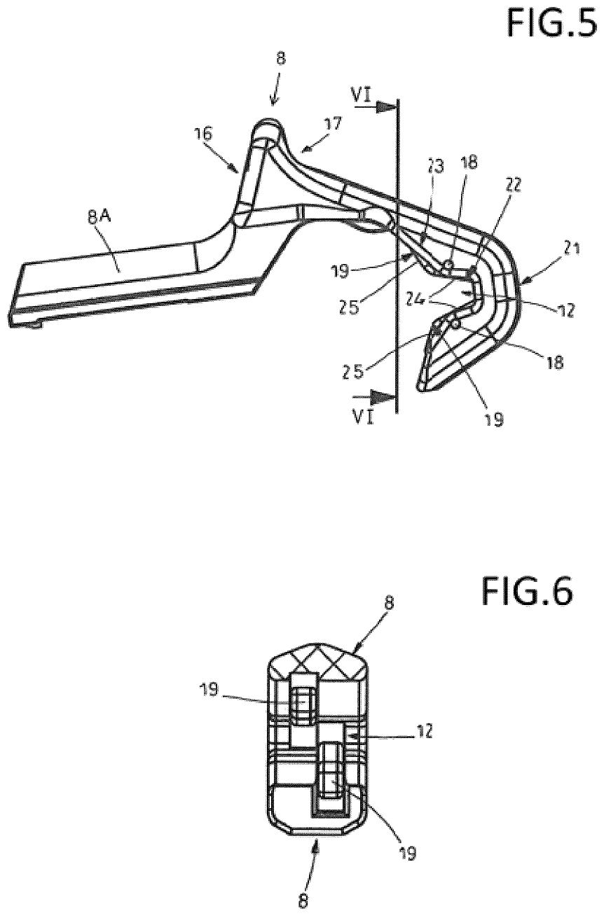

FIGS. 4 and 5 illustrate a second embodiment of the cable knife 1, in which two guide elements 19 are mounted in the cable recess 12 in the slide 8. These guide elements 19 are offset laterally to each other, i.e., the offset is transverse to the longitudinal direction of the cable knife 1, so that the cross-sectional plane in FIG. 4 runs through only one of the two guide elements 19, and thus, the second guide element 19 is not visible in this illustration. Both guide elements 19 are, however, clearly shown in subsequent figures that are described below. Each of the guide elements 19 is pivotably mounted on a pivot pin 18, so that the guide elements 19 are able to pivot freely upwardly or downwardly on the pivot pins 18, whereby the extent of the pivot is limited by the inner contour 20 of the slide 8. The offset of the two guide elements 19 allows the elements to assume angled positions in which each guide element 19 extends beyond a longitudinal centerline of the cable.

The guide elements 19 project into the cable recess 12, so that the portion of a flat cable that runs through the cable recess 12 makes contact primarily with the guide elements 19, rather than with the walls of the cable recess 12 itself. This reduces the frictional resistance when the flat cable is pulled through the cable channel 32 of the cable knife 1 to make a longitudinal cut into one of the two narrow sides of the flat cable.

FIG. 5 illustrates just the slide 8 with the guide elements 19 and the cable recess 12. The slide 8 has slider arm 8A that is mounted in the handle 2 in a manner that allows the hook-shaped free end 21 of the slide 8 to be pushed away from or closer to the handle 2. In the embodiment of the slide 8 shown here, the cable recess 12 is formed at the free end 21 of the slide 8 and has a base and two recess walls that extend symmetrically to each other from the base in the direction of the handle 2. A first section of the recess walls forms a first recess section 22 that is closer to the free end 21 of the slide 8, and a second section of the recess walls form a second recess section 23 that is closer to the handle 2. The transition in the recess walls from the first recess section 22 to the second recess section 23 occurs in the vicinity near the pivot pin 18. In the two recess sections 22 and 23, the recess walls are not parallel to one another, but rather open up at an angle in the direction of the handle 2, thereby forming an approximately V-shaped space. The two recess walls in the first section 22 are at a more acute angle to one another than the recess walls in the second recess section 23. In the embodiment shown, the two recess walls in the first section 22 are almost parallel to each other, thereby forming a narrow channel that serves to reliably guide thin flat cable through this region of the cable recess 12. The two recess walls in the second section 23, by contrast, open out ever wider as the distance from the free end 21 of the slide 8 increases, thereby forming a sufficiently large open space for receiving thicker flat cable and round cable. Depending on the thickness of the flat or round cable, the cable is closer to or farther from the center of the guide groove 14, so that the operator uses the adjustment wheel 9 to set the blade 15 to the proper depth in the groove 14 to produce the desired depth of cut.

In the illustrated embodiment, the walls of the cable recess 12 in the two recess sections 22 and 23 extend in a straight line. In contrast to the embodiment shown, it is understood that the walls of one or both of the recess sections 22 and 23 may be curved, and the two sections together may even present a continuously curved contour.

As is the case with the cable recess 12, the guide elements 19 also have two different guide sections 24 and 25, best seen in FIG. 5. The first guide section 24 is closer to the free end 21 of the slide 8 than the second guide section 25. As shown, the second guide sections 25 of the guide elements 19 form a second open space closer to the handle 2 that expands more sharply and wider than does a first open space formed by the first guide sections 24.

FIGS. 4 and 5 show that the two guide elements 19 project into the first recess section 22 and the second recess section 23 of the cable recess 12, and provide the contact surface for a flat cable that is inserted into the cable recess 12.

FIG. 6 is a cross-sectional view in the longitudinal direction of the slide 8 along the line VI-VI in FIG. 5, showing that the two guide elements 19 are laterally offset from each other.

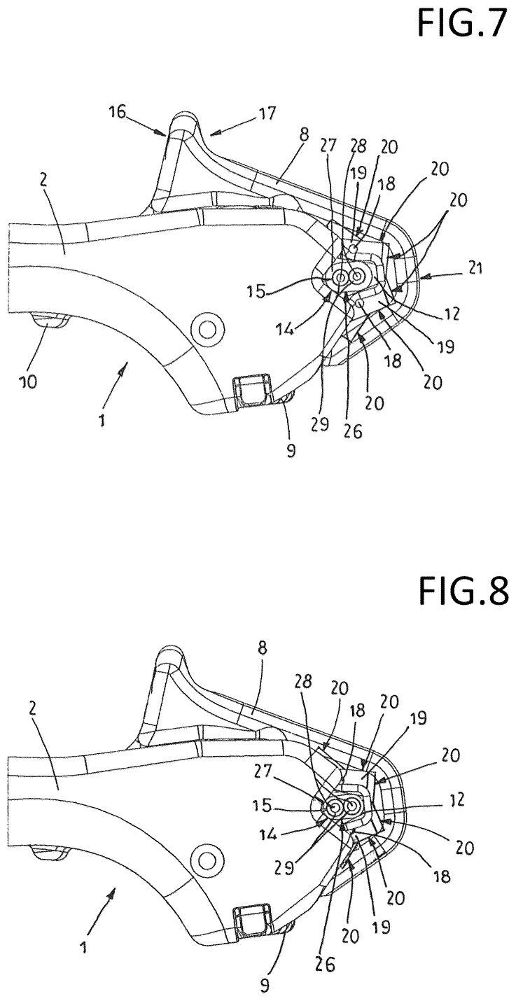

FIG. 7 is a plane elevation view of the slide 8 and a front portion of the handle 2, showing the various components in greater detail. A flat cable 26 has been inserted into the cable channel 32 and one side of the cable is in contact with the recess walls in the first recess section 22 and other side is in contact with the guide groove 14. The blade 15 is shown cutting into an outer insulation sleeve 27 on the narrow side of the flat cable 26. The flat cable 26 contains two electrical conductors 28, each of which has an insulation sheath 29. In this illustration, the flat cable 26 is so thick, that it does not make contact with the base of the cable recess 12, but instead forces the two guide elements 19 apart. The inner contour 20 of the slide 8 serves to limit the movement of the two guide elements 19.

FIG. 8 is an illustration similar to that of FIG. 7, but showing a thinner flat cable 26 than the one shown in FIG. 7. The slide 8 in FIG. 8 is closer to the handle 2 than in FIG. 7, so that the pivot pins 18 are partially covered by the handle 2 in the region of the guide groove 14. In contrast to the flat cable 26 of FIG. 7, the thinner thickness allows the flat cable 26 to fit completely within the cable recess 12, without pressing the guide elements 19 apart, thereby allowing the slide 8 to move closer to the handle 2. The guide elements 19 are not pressed against the inner contour 20 of the slide 8, which would serve as a stop to further movement, but rather, maintain a certain amount of play around the pivot pins 18. The blade 15 has been adjusted to project into the guide groove 14 to make a longitudinal cut in the outer layer of insulation 27 as the flat cable 26 is pulled lengthwise through the cable knife 1, but not so far as to cut into the insulation 29 of an electrical conductor 28.

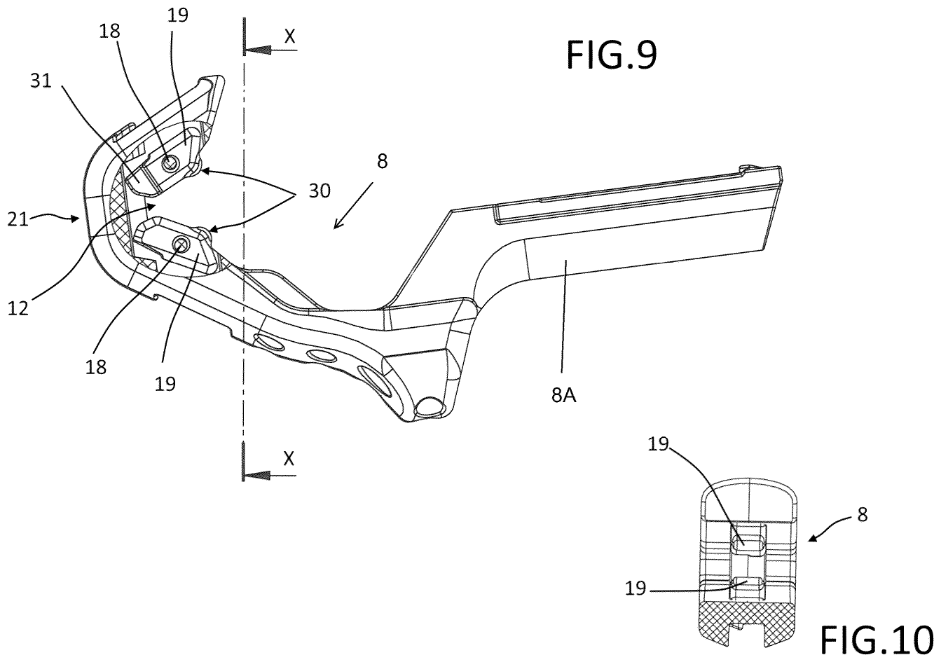

FIG. 9 is a plane elevation view of the slide 8, showing a third embodiment of the cable knife 1, in which the two guide elements 19 deviate from the above-described embodiment in three respects. First, a bead 30 is provided on a section of each guide element 19 at a position that is farther away from the free end 21 of the slide 8 than the respective pivot pin 18. These beads 30 point toward the respective other guide segment 19, thereby effectively narrowing the clearance profile in the cable recess 12. Second, a reduced width, i.e., a notch 31, is provided in each of the guide elements 19 in an end of the guide element 19 that is closer to the free end 21 of the slide 8 than is the respective pivot pin 18. Third, and this cannot be discerned in the illustration, the guide elements 19 are not arranged offset with respect to one another along the longitudinal axis of the cable to be received in the slide 8 or the longitudinal axes of the pivot pins 18 that run parallel thereto, but rather, one above the other. But in order to ensure the greatest possible pivoting mobility of each guide element 19 about its respective pivot pin 18, the notches 31 are provided at the end of the guide elements 19 where they could possibly collide with each other when pivoting to an extreme position that pivots the ends into a narrow region at the free end of the slide 8. The notches 31 are offset with respect to one another, thereby allowing the notched ends of the guide elements 19 to move into a position where they fit up against each other side by side.

FIG. 10 shows a section through the slide 8 along the line X-X indicated in FIG. 9. As can be seen, the two guide elements 19 are not offset but are mounted congruently, i.e., one above the other, in the slide 8. The notches 31, however, are offset to each other, so that the notched tip of one guide element 19 can fit next to the notched tip of the other guide element 19.

FIG. 11 is a cross-sectional view of the slide 8 through the length of the slide 8. Due to the plane along which the cross-sectional cut runs, the notch 31 in the guide element 19 is visible only in the upper one of the two guide elements 19. As can be seen, the notch 31 is provided only over a small portion of the entire width of the guide element 19.

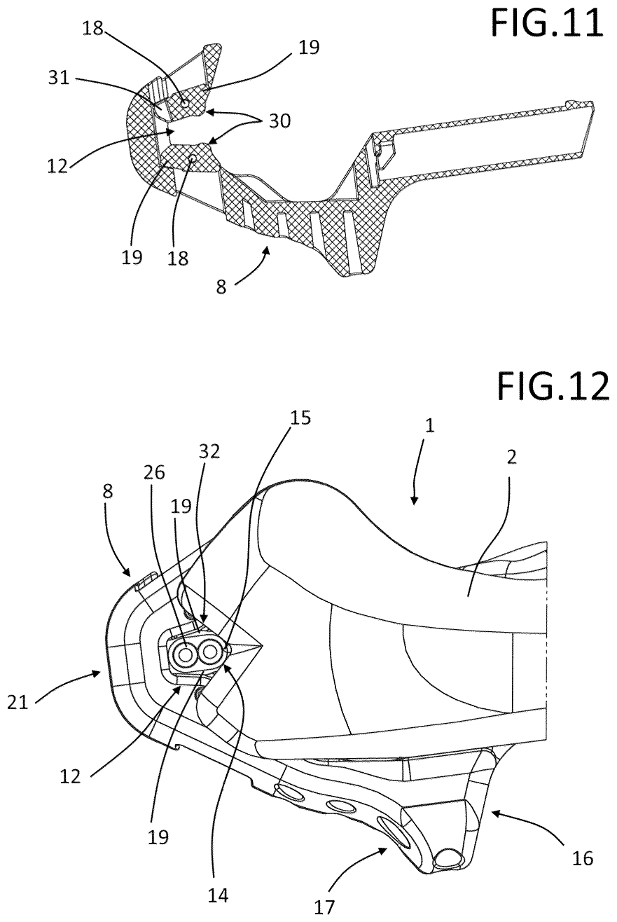

FIGS. 9 to 11 show the position that the guide elements 19 automatically pivot to, when a small flat cable is inserted into the cable recess 12. The guide elements 19 assume the same position in FIG. 12.

In contrast to FIGS. 9 to 11, FIG. 12 shows not only the slide 8, but a section of the cable knife 1 that illustrates how the guide groove 14 on the handle 2 and the cable recess 12 on the slide 8 together create the cable channel 32. A flat cable 26 has been inserted into the cable channel 32 and the blade 15 adjusted to make a cut into the outer layer of insulation on the cable. In this embodiment of the cable knife 1, the blade 15 is mounted so as to be rotatable at least 90° upward or downward to make a circumferential cut, but is shown here positioned to make a lengthwise cut into the outer layer of insulation.

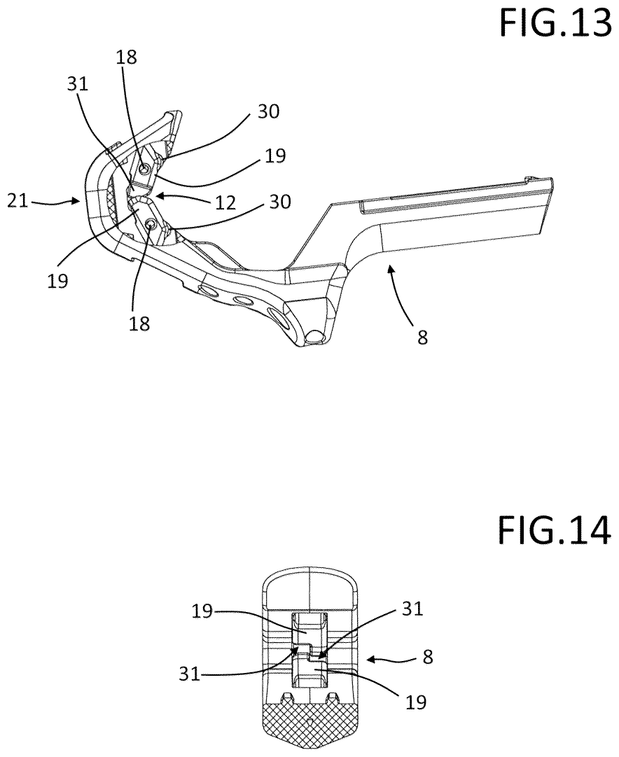

FIGS. 13 to 15 are similar illustrations of the slide 8 illustrated in FIGS. 9 to 11, but in these illustrations, the two guide elements 19 are in an orientation that they automatically assume when a round cable of large diameter is inserted into the cable knife 1. In this illustration, the round cable does not fit into the first recess section 22 and has forced the guide elements 19 to assume an extreme pivoted position, thereby creating a larger open space in the cable channel 32. Thus, the shape of the cable channel 32 in this example differs from the shape of the cable channel 32 shown in the FIGS. 9 to 11. These figures illustrates how this embodiment of the cable knife 1 is able to receive round cables up to a diameter of 13 mm. In this extreme pivoted position, the reduced thickness areas of the notches 31 completely overlap each other, as shown in FIG. 14.

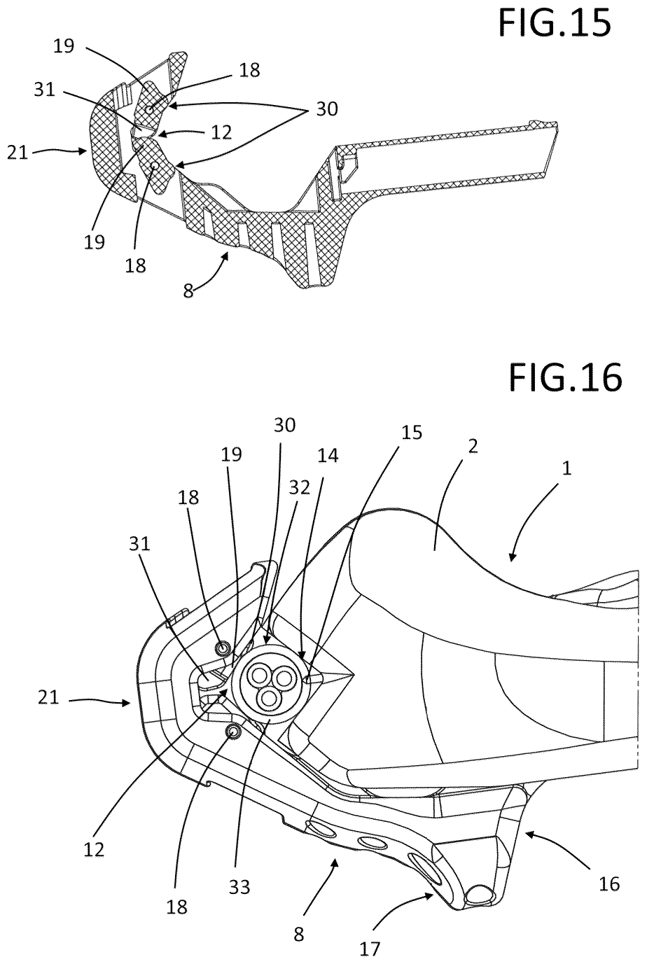

FIG. 16 is a further illustration of how the shape of the cable channel 32 changes, depending on the shape or dimension of the cable inserted into the knife 1. The illustration is similar to that shown of FIG. 12, but here a round cable 33 having an average diameter of perhaps 9 mm is inserted into the guide opening 32. The guide elements 19 assume a different pivot position with this smaller dimension than the positions shown in FIGS. 13 to 15, in which they are pivoted to a position they would take if a large round cable of 13 mm were inserted. The areas of the notches 31 on the two guide elements 19 do not overlap each other, as the two notched ends of the elements 19 are not in a position in which they would be side by side. Also, because of the position the guide elements 19 have assumed, the beads 30 only extend into a region of the cable recess 12.

FIG. 16 also shows the blade 15 positioned to make a lengthwise cut in the outer layer of insulation on the round cable 33. As previously mentioned, the blade 15 is mounted so as to be rotatable through 90°, so that the blade 15 may be used to make a circumferential cut on round cable, as well as a lengthwise cut in the insulation. The blade 15 may be a double-edged blade, so that the direction of rotation is freely selectable. The operator rotates the round cable 33 about its longitudinal axis in order to make a cut around the complete circumference of the cable.

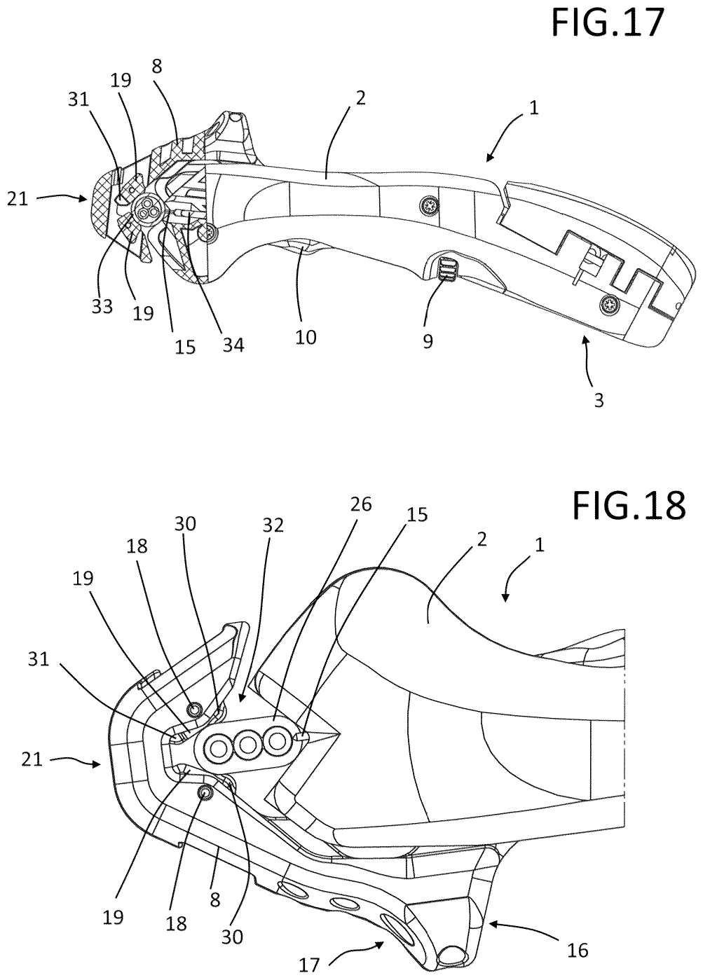

FIG. 17 shows the entire cable knife 1 with the round cable 33 shown in FIG. 16, and shows a cross-sectional view of the slide 8 and parts of the handle 2. The blade 15 is provided at the end of a knife shaft 34 that is connected to the adjustment wheel 9, which in this embodiment is located in greater proximity to the stripping section 3 than in the embodiment shown in FIG. 1.

FIG. 18 is a further illustration of how adaptable the cable knife 1 is to the specific geometry of the cable to be processed and how the shape and size of the cable channel 32 changes, depending on the specific geometry of the cable. In this illustration, a flat cable 26 that is larger than the flat cable 26 shown in FIG. 12 is inserted into the cable opening 32 of the cable knife 1. This larger flat cable 26 forces the slide 8 farther out from the handle 2 and the guide elements 19 assume a different pivot position. One can see when comparing the configurations of the cable channel 32 in FIGS. 12 and 18, that the cable channel 32 changes significantly in shape and size in response to the geometry of the cable inserted into the channel.

It is understood that the embodiments described herein are merely illustrative of the present invention. Variations in the construction of the cable knife may be contemplated by one skilled in the art without limiting the intended scope of the invention herein disclosed and as defined by the following claims.

What is claimed is:

1: A device for stripping wire from a cable, the device comprising:
a handle,
a slide that is attached to the handle, the slide having a free end that is hook-shaped and is movable relative to the handle,
a cable channel formed between the handle and the free end of the slide, the cable channel having a first side that is defined by a guide groove and second side defined by a cable recess,
two guide elements that are movably mounted on the slide and extend into the cable recess, and
a blade that projects into the guide groove,
wherein when a round or flat cable is inserted into the cable channel, the two guide elements automatically assume an inclined angle, depending on a specific geometry of the round or flat cable, and the cable channel automatically adapts in shape to accommodate the specific geometry of the round or flat cable, and
wherein, when the round or flat cable is pulled lengthwise through the cable channel, the blade makes a longitudinal cut in an outer layer of insulation on the cable.

2: The device of claim 1, wherein the cable recess has a recess base and two recess walls,
wherein the two recess walls form a first recess section that extends outward from the base, the two recess walls of the first recess section together forming a first opening angle that is an acute angle,
wherein the two recess walls then form a second recess section that extends from an end of the first recess section that is farther away from the base, the two recess walls in this second recess section being angled outward from the first recess section, thereby forming a second opening angle that is wider than the acute angle of the first recess section,
wherein, the first recess section serves to prevent a flat cable that is being pulled through the cable channel from twisting about a longitudinal axis of the cable and thereby moving away from a desired orientation toward the blade.

3: The device of claim 2, wherein an end on each of the two guide elements that extend toward the free end of the slide have a reduced width, so that when the two guide elements tilt to an oblique opening angle, the two ends are able to move to a position in which they are side by side.

4: The device of claim 3,
wherein the two guide elements are mounted opposite each other and each has a region with a reduced width that avoids a collision of the two guide elements when they assume inclined positions at an oblique opening angle.

5: The device of claim 1,
wherein the each of the two guide elements is pivotably mounted.

6: The device of claim 1, further comprising:
a bead that is provided on each of the two guide elements,
wherein the bead reduces a clearance area in the second recess section.

7: The device of claim 1,
wherein the guide groove is provided on the handle and the cable recess on the slide.

8: The device of claim 7,
wherein the guide groove has a V shape that widens in a direction toward edges of the handle.

9: The device of claim 7,
wherein the blade is longitudinally adjustable in such a way that it projects out of the handle to varying lengths in order to adjust the depth of cut in an outer layer of insulation on a cable.

10: The device of claim 7,
wherein the blade is mounted so as to be spring-movable and is retractable into the handle against the action of the spring.

11: The device of claim 1,
wherein the blade is a double-edged blade that enables incisions to be made in an outer layer of insulation on a flat cable in both directions in the longitudinal direction of the cable.

12: The device of claim 1,
wherein the blade is mounted so as to be rotatable in such a way that it is selectively rotatable through 90 degrees in an upward and a downward direction, so as to enable the blade to make a cut in a circumferential direction of the cable.

13: The device of claim 1,
wherein the slide has an opening surface that is used to move the free end of the slide away from the handle by applying pressure to the opening surface, thereby forcing the free end of the slide to move out from the handle against the spring force.

14: The device of claim 13,
wherein the slide has a closing surface that facilitates moving the free end of the slide closer to the handle by applying pressure to the closing surface.

15: The device of claim 14,
wherein the opening surface is on a first side of a protuberance on the slide and the closing surface is on a second side of the protuberance
